(19) United States
(12) Patent Application Publication
(10) Pub. No.: US 2024/0054534 A1
(43) Pub. Date: Feb. 15, 2024

(54) USER-DESIGNED PERSONALISED SEARCH WEB-BASED PLATFORM FOR PRODUCTS AND SERVICES

(71) Applicant: PERSONALISED ONLINE DIRECTORIES PTY LTD, Sydney, NSW (AU)

(72) Inventor: Tonie AMOS, Sydney, NSW (AU)

(21) Appl. No.: 18/278,197

(22) PCT Filed: Feb. 22, 2022
(86) PCT No.: PCT/AU2022/050125

§ 371 Date: Aug. 22, 2023

(30) Foreign Application Priority Data
Feb. 22, 2021 (AU) 2021900464

(51) Int. Cl. G06Q 30/0251; G06Q 30/0204

(52) U.S. Cl. CPC G06Q 30/0271; G06Q 30/0205

(57) ABSTRACT

A personalised online search for products and services within a self-contained online marketplace. It comprises multiple websites, each with a unique domain name. Users design their search pathway by click button options (or touch screen) based on user type—websites compiled as a tree structure. The button options for consumer customers are primarily based on psychographic or demographic choices, while the button options for Business-to-Business (B2B) customers are based on business or market-type. Users' personalised search results are listed via third-party directory websites that are customised to their search requirement—thereby matching their search query to qualified advertisers. Advertisers, by means of new application software, use a single sign-on account dashboard and Do-it-Yourself Online Marketing System to duplicate their digital content in real time to their preferred markets or websites—a process that encourages advertisers to customise their offerings to their preferred customers.

### REFERENCES CITED

### Patent Documents

U.S. Ser. No. 08/326,861 December, 2012 Google Inc.
EP167373 June 2006 Google Inc.
CN11124147 June 2020 Renmin University of China
CN104462357 November 2017 Baidu Online Network Technology (Beijing) Co
CN101667199 September 2009 Zhejiang University
US20160034464 February 2016 Linkedin Corporation
CN104484380 April 2015 Baldu Online Network Technology (Beijing) Co
KR102006011642 November 2006, NHN Corporation
US2000195588 August 2008 NHN Corporation
KR1020060115488 November 2006 NHN Corporation
CN104077334 October 2014 Beijing Thousand Oaks Wangjing Technology Development Co., Ltd.
CN112182154 January 2021 Renmin University of China
CA2549440 July 2015 Google Inc.
US201103148 June 2011 Google Inc.
CN102819575 December 2021 Nanjing University
CN102567376 July 2012 China Mobile Group Zhejiang Company Umited
CN101667199 March 2020 Zhejiang University
US20180081973 June 2020 International Business Machines Corporation
CN108399575 August 2018 Dalian University of Technology
US20140324849 October 2014 eBay Inc.
CN1066611340 May 2017 Alibaba Group Holdings Ltd
AU2012202738 May 2012 Google Inc.
LS61893 February 2001 WynWyn.com Inc.
US2014030483 October 2014 AT & T Intellectual Property, L.P.
U.S. Ser. No. 10/706,115 July 2020 Google LLC
WO2021189583 September 2021 Jiangsu University of Science & Technology
AU1999062723 July 2000 WynWyn.com Inc

### Other References

McKinsey&Company “Perspectives on Personalization @ Scale”, Vol. 1 Jul. 2018
Bao, L. Sun, X, Chen, Y Gong, D. Zhang, Y “Restricted Boltzmann Machine-Driven Interactive Estimation of Distribution Algorithm for Personalized Search”, Knowledge-Based Systems, Volume 200, 20 Jul. 2020

### Background—Including Prior Art

In the last 20 years, the most popular means for people to search for products and services is to use search engines on the World Wide Web. These include Google®, Bing® and Yahoo®.

These search engines are designed by database and software engineers working with everchanging algorithms. Algorithmic search processes are misunderstood by users—typically consumers or business owners with little or no relevant technology knowledge (for example, Search Engine Optimisation or SEO). SEO experts also admit that keeping up to date with the field is a challenge—and yet it remains a popular web searching tool.

In non-technical terms, the SEO process involves using the users' search history, combined with spiders (internet bots) that systematically browse the World Wide Web to find related content—to generate search results. There is no business requirements or user requirements statement behind the development of the search process.

Search engines such as these generate adhoc results and can be unreliable for many reasons. Firstly, it is common knowledge that many users do not scroll past Page 1 of the search results. The possibility of an ideal match of buyer and seller requirements positioned on Page 1 is unlikely.

Secondly, this method of search does not consider dynamic user preferences nor the current user context. For example, a School Principal may be searching for products and services for their school, then search for a handbag for personal use. In this case, the browsing history is confused and unreliable. It also does not account for the significant differences in purchasing goals for businesses compared to consumers. And in a related issue, the search query term does not consider the users' preferences or interests—or indeed the semantics of meaning intended behind the search term. For example, the intended meaning of including the search keyword term “tree” will vary depending on the user—and their current search requirement. Even if the same search keyword had identical semantic meaning (a type of tree)—required search results would be different for say, a plant nursery (looking for plant stock), than a consumer looking for a tree.

Thirdly, search results of the advertisers' offerings change depending on the user search history. For example, while an SEO expert has proved to the advertiser that they are appearing on Page 1 for a keyword search term, this is most likely because the advertiser commonly “searches for themselves” unbeknownst to them—generating a different search result than their target customers. Also, the SEO expert or advertiser may not be aware of which search terms their target customer uses for a typical search.

In summary, SEO is expensive and confusing for advertisers—and does not involve a system that qualifies the advertisers' offering to the customer.

It is my opinion that the popular Google® (and similar) algorithm system is best designed for users to find general and specific information, rather than product and service search results. It is indeed a technological marvel that the complex database and algorithm system collects and stores an unlimited library of data from websites and online forums across the world (for example, researching a tope of interest or how to carry out a task)—and, combined with clever and wide-ranging algorithmic keyword search, generates a useful search result.

The SEO and related algorithm processes are constantly evolving to move into the era of big data. For example, CN112182154 (Renmin University of China, January 2021) addresses ways to use AI to eliminate keyword ambiguity by using “personal word vectors”. Many of the references cited include methods to improve the user data collection process, including analysis of favourites or bookmarks of a user's web browser.

Another example CA2549440 (Google Inc July 2015) addresses a means to provide a search result of news content personalised to the user (information-based search approach).

Personalisation and Privacy Issues

Personalisation is emerging as a strong trend in this decade as a powerful digital marketing tool. McKinsey&Company (2018) recommends to “put personalization at the centre of your marketing to drive growth”. This is also recognised in the software development and database management field; as personalised search technology is a hot spot in research that has resulted in some related product development.

This is demonstrated by the plethora of prior art in relation to advancements in the field of personalised (personalized) search—whereby search results are driven by interactive algorithms. See sample list cited. For example, references to the Boltzmann Machine [RB]—driven interactive personalized search method (WO2021189583 Jiangsu University of Science & Technology September 2021) and Bao et al (2020)—demonstrate the pursuit of a better personalised search for users—with attempts to consider dynamic user preferences.

In more recent Artificial Intelligence (AI) and sensor technology, US20180081973 (International Business Machines Corporation June 2020) puts forward a process whereby sensors detect and report physiological and behavioural patterns in the user.

A major recommendation from the McKinsey cited article is to “Give me relevant recommendations I wouldn't have thought of myself”. A personalised search based on user data will not generate this outcome as it relies on user search keywords. Google Ads (AU2012202738, Google Inc. May 2012 as an example) to some extent addresses this issue. For example, the inventor of a ride sharing app Uber® knew that their target market would not search for “ride sharing app”. Instead, the company posted Google Ads based on psychographic data.

The social network field has also advanced the personalised search approach. For example, Google®'s personalised search (U.S. Ser. No. 10/706,115 Google LLC July 2020) considers the users' personality, preferences and interests—that is search result related to the user's psychographic profile. This approach generates a personalised search via the users' social network profile.

There Is also a field of work to predict a users' personality using computer analysis of text used in the users' social media posts (CN108399575 Nanjing University December 2021). Notwithstanding the psychological validity of this process.

In US20160034464 (February 2016) the Linkedin® Corporation put forward a personalised search based on the users' interests—analysed from their search queries and posts on the platform.

In a social network context, however, the user is not actively seeking a product or service at the time of using the platform—which is mostly for social reasons. And therefore, less likely to make a purchasing decision on the spot while using the platform.

The forementioned online conventional search processes, in addition to emerging technologies personalised search processes, collect user data to generate search results, or indeed personalised search results for products and services. Internet users are becoming more aware of privacy issues.

That is, concern over what personal data is being collected on searches undertaken online—and how their personal data will be used in the future. This is referred to as the “creep factor” in the earlier cited McKinsey article.

Considering privacy invasion issues, CN101667199 (Zhejiang University September 2009) puts forward a computer system solution to assist with the trade-off between personalised search quality and privacy protection.

The issue with any search process that relies on user data “behind the scenes”—albeit privacy protected—does not offer a transparent approach where users can identify new ways to improve the quality of their search results. That is have control over their search process. For example, a new search may be totally unrelated to their current search requirement. In addition, this method can be highly expensive for advertisers as “bot programmes” are used to generate clicks to improve advertising revenue for the platform—instead of clicks from genuine prospective customers. Advertisers are generally concerned about this type of “click bait” advertising as they have no control over positioning their digital content in front of their preferred markets—at an agreed price. This leads onto the same forementioned issue with SEO-based search whereby the lack of capacity to position advertisers as qualified sellers to the customers' current requirements.

The Directory Approach

In light of the above, directory websites are becoming more popular to search for products. Popular wide scope directories Alibaba® and eBay® differentiate between the Business-to-Business (B2B) context and the consumer context—as separate platforms. However, they do not offer a personalised search result. For example, in the case of eBay®, there is no search capability to search for dresses most suitable for a female in her early 20's. In addition, Alibaba®'s search category system for markets is essentially a product categorisation system (for example, Vehicle Parts and Accessories—and Machinery). These platforms are also more designed for product search, rather than service search. There is no functionality for users to search interchangeably for a product or a service. Although eBay in 2014 put forward US20140324849 (abandoned) a personalised search widget which is limited to the algorithms putting forward search suggestions for the user based on their past searches and selection of categories. In CN1066611340 Alibaba Group Holdings Ltd (May 2017) puts forward a more personalised approach to the search results display (not to the content of the search results themselves).

These popular directory websites also operate from webpages on sub-domains. That is, the directory system operates from one primary domain that is, Alibaba.com or ebay.com. For example, a user search for a “leather handbag” on eBay results with a url of:

www.ebay.com.au/sch/i.html?_from=R40&_trksid=p2330057.m570.11313&_nkw=handbag+leather &_sacat=0 In addition, the product category and location is not included in the url and would be very difficult for the user to find on a repeat search—unless is saved as a Favourite url or favourite search on the eBay website. This approach is also not optimal for SEO purposes for general searches online as it does not place priority on the product category and location.

There are many independent directories using third-party software with a sophisticated front end search for the user and back-end administration console—whereby product categories and locales may be included in the url. For example: www.websitedirectory/handbags/leather/Sydney.

Search results are also more likely to be personalised to the requirements of different markets and user data collection is not mandatory.

These directories are more likely to match customers to qualified advertisers. The advertisers use sophisticated, yet user friendly dashboards to upload digital content. However, the issue with directory websites is the narrow scope of market, product category and location. The directory and search results are niche-specific and do not offer a large scope or range of products and services on offer in different markets or consumer interests. For example, a dentist directory in California provides a sophisticated search process and results for dentists in California—and nothing further.

Multiple directories (with forementioned third party software) with multiple websites could widen the scope—however it is an arduous process for either advertisers or administrators to duplicate advertiser content across the directory website network—and further customise to market requirements.

The expired U.S. Pat. No. 6,189,003 (filing date: 23 Oct. 1998, WynWyn.com Inc.) and AU1999062723 (filing date: July 2000, WynWyn.com Inc.) provide a greater scope in a product and service type directory that matches buyers with advertisers when buyers are ready to buy—however this solution involves using business listing third party data which is not optimal with new privacy laws worldwide. It is also a resource intense approach with a significant time required for human contribution for each buyer/seller interaction.

The abandoned US20140304083 (AT & T Intellectual Property, L.P. October 2014) addresses the resource intense and narrow scope issues of the forementioned business directories by a system and method of targeting advertisements of subscribers from directories. However again this method does not address the user data privacy nor user control issues—as the platform is not self-contained.

### SUMMARY

In view of the above, this submission shifts from the fore mentioned pursuit of a complex technology solution to address the big data environment to search for products and services. The overall design concept is more user or business requirements-driven than technology-driven.

As an alternative to exploring existing data on the web, this approach sets up a new realm or online marketplace where advertisers can easily post and duplicate content online to their preferred markets. In addition, users design their own search strategy to account for their dynamic preferences.

This is a web-based platform for a user to design and conduct a personalised search for any product or service offered by advertisers.

It is achieved by a self-contained platform with a multiple directory website design.

The first component of the search process is achieved by a Tree Structure—or “click button” design—of the websites—thereby making the search “user-designed”. These websites are composed of various website groups of website portfolios (for example, Health Suppliers) to match the user type.

The search process is personalised because the click button options are either based on:
The users' psychographic (or demographic) profile (for consumers). For example, seniors; or women

In their early 20's.
The users' type of business (for Business-to-business searches). For example, schools or hotels.

The second component of the search process is a network of third-party online directories customised to either the users' psychographic or demographic profile, or type of business—each with their own domain names. The online directory websites are fully customised to the customers' search requirements. It includes keyword search and Google Maps® capability. That is, the search results displayed match the product or service the customer is currently seeking, in addition to current availability in their desired location.

Current popular search engines commence by a text-based search—where search results are linked back to algorithmic crawls of the users' search histories. This search commences by various “click buttons” which translate easily to touch screens in, for example, ubiquitous mobile devices. In this way the user quickly discounts those parts of the search that are irrelevant to their needs.

All websites have a unique domain name. The process does not operate from sub-domains.

In addition, application software has been developed so that advertisers of products and services complete an easy “tick box” of websites—that is, markets—of their choice—on the “master” advertiser website—from a single sign on dashboard. In addition, posting digital content relevant to their products and services—including products, photo galleries and blogs or articles. Advertisers can also list their service locations via this Do-it-Yourself (DIY) Online Marketing System. The digital content Is then cloned in real time to their choice of “slave” websites—thereby saving them significant time.

In summary, the impetus of this platform solution is the element of control and transparency for all users.

That is:
1. Personalisation for customers. Users create their own search pathway to find products and services most suitable to their needs, that is, conduct a personalised search; and
2. Customisation for advertisers. Advertisers, or suppliers of products and services, can design their own marketing strategy by using a checklist of available websites to post their digital content—and position their offerings to their preferred customers. That is, they know exactly where and how to post and showcase their products and services on the internet using a single platform.

### DESCRIPTION

The search process for products and services presented here is designed to enable a personalised search for users. It overcomes the lack of privacy, transparency and user control issues of prior art—and, unlike personalised search that uses social networks, is applied at the time the user is ready to research or make a purchase decision. It is also more likely that qualified advertisers appear in a users' search results.

The platform or software solution is self-contained—and does not rely on web-based data. The use of third-party directory software as part of the ensuing solution enables quality search results at a granular level.

This embodiment also overcomes the narrow scope issue of directory websites. The process is also designed for both products and services—overcoming the singular focus on products of popular directory websites—and users can search for, and advertisers list, both products and services interchangeably. This is achieved by a newly developed Product and Service Framework that overarches the online marketplace.

These and other benefits of one or more aspects will become apparent from a consideration of the ensuing description and accompanying drawings.

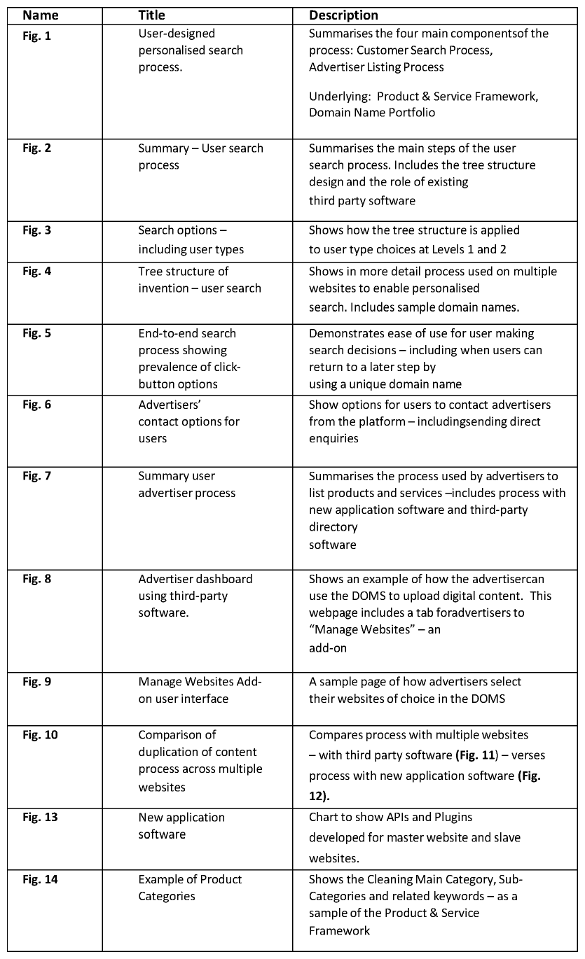

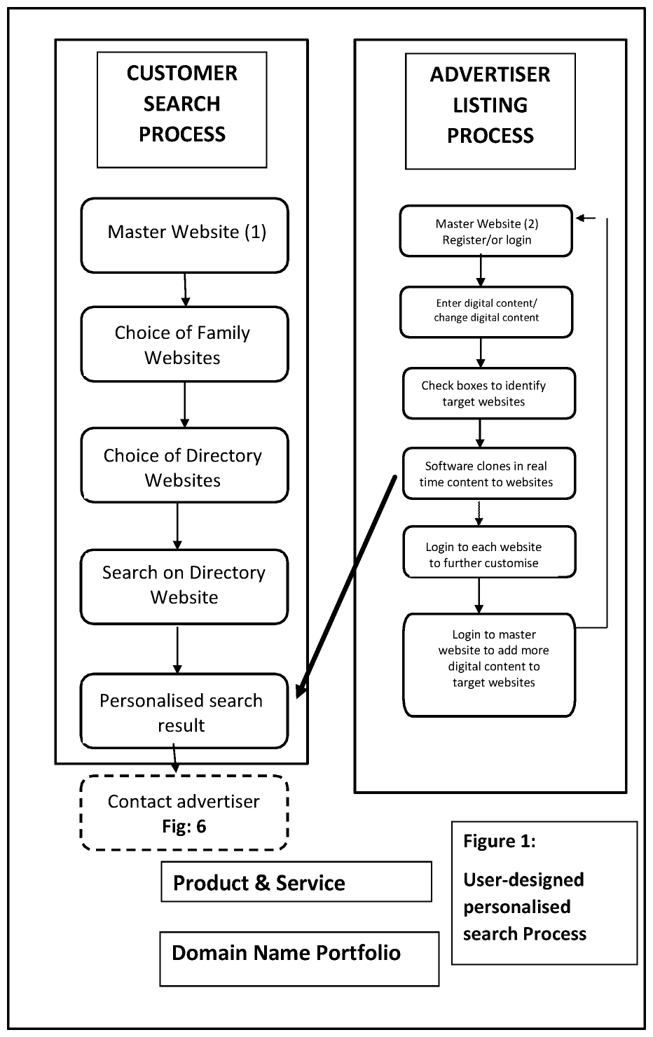

FIG. 1 summarises the overall process for both customers (searchers) and advertisers via this software platform. The customer search process is integrated with the advertiser listing process—both comprised of multiple directory websites.

A Product and Services Framework—designed for this platform—underpins the process.

The perception of the customer of the described end-to-end search process is a controlled search pathway from a single software platform, that is user-designed. The customer search is first initiated from one Master Website. The advertiser listing process is from another Master Website comprising a single sign-on member dashboard—using a DIY (Do-it-Yourself) Online Marketing System, or DOMS. Multiple sign-on to multiple websites by advertisers is then required—for further customisation—once initial digital content has been uploaded to the platform. The goal to provide a user friendly, fast and easy process for both customers and advertisers.

New application software has been developed to address the “missing link” of existing third-party directory software to replicate advertiser's digital content across selected directory websites.

While the overall solution presented is software-based for automation purposes—for both customers and advertisers, it includes a human element of sourcing advertisers to “fill in gaps in search results” to provide a complete solution.

For the sake of brevity:

The terms “products and services” will be referred to as “products”.

The term “customers (searchers)” will be referred to as “customers” or “searchers” interchangeably.

The terms “advertisers of products and services” will be referred to as “advertisers”. Other related terms used elsewhere and herein are “sellers” and “suppliers”.

The term “click button” will be referred to as “button”.

The term “DIY Online Marketing Software” will be referred to as “DOMS”.

Users can be both “customer” or “searchers”- or “advertisers”—depending on context.

The term “personalised” is English spelling of the term “personalized” (US).

The term “Business-to-Business” will be referred to as B2B.

The term “third-party directory software” can refer to any existing directory software that offers advertisers a professional online profile. It needs to have sophisticated search capacity including keyword and location search, administration console that permits back-end administration of multiple websites, all forementioned digital content and a lead (or enquiry) management system.

For commercial purposes, an advertiser subscription model—preferably with different monetary levels. For example, Brilliant Directories software offers these features.

The term “platform” or “software platform” is used—implied meaning is that the total software solution can controlled by one user entity (that is, doesn't rely on websites owned by others)—noting that both the customer search process and advertiser listing process is not from one centralised software platform.

The term “digital content” is a generic term for the digital content included herein—which includes business profile, website links, links to social network pages, articles or blogs, videos and photo galleries.

SEO is an algorithm for Search Engine Optimisation.

Customer Search Process

Personalised search is web search results that are tailored specifically to an individual's interests by incorporating information about the individual beyond the specific query provided (Source: Wikipedia). The web search results include digital content provided by the advertiser—and can include website links, links to social pages, business profile, videos, articles or blogs and product categories.

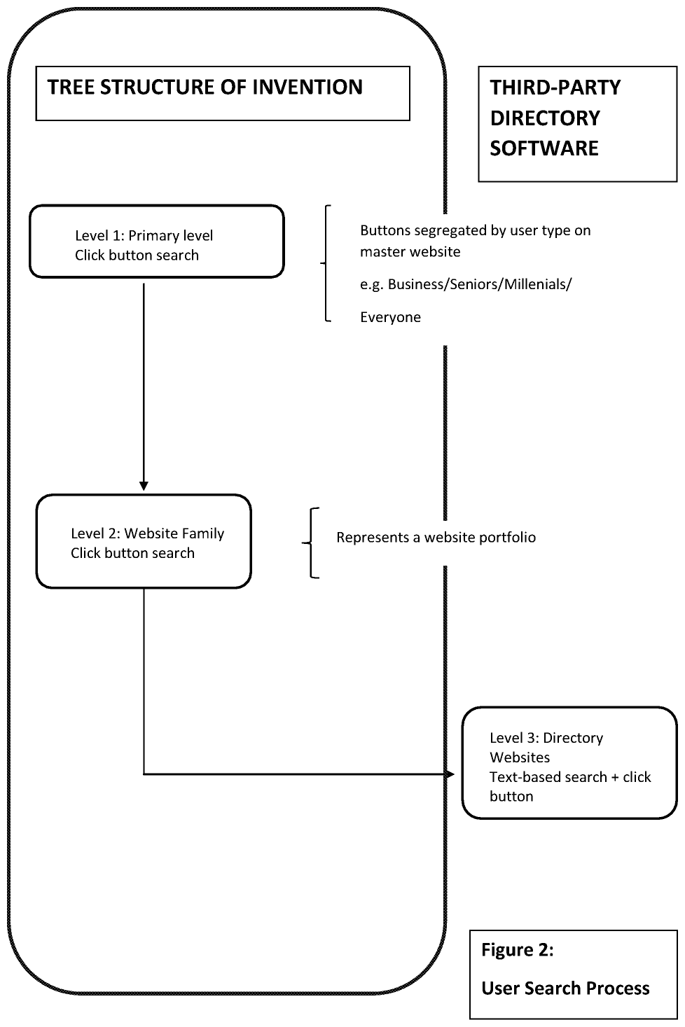

The customer search process for products and services (FIG. 2) to generate this personalised search—has three levels displayed as a tree structure:
1. Primary level
2. Website Family
3. Directory website

The parts of the user search process that comprise new software versus third-party directory software also shown (FIG. 2).

Levels 1 and 2 are web pages designed in simple HTML program code—with button options that link to connected websites in the tree structure. The segregation of the search into buttons is user friendly—quick and easy to use—without text input.

Level 3 are the networks of Directory Websites (third party provided) structured in meaningful clusters from Level 2.

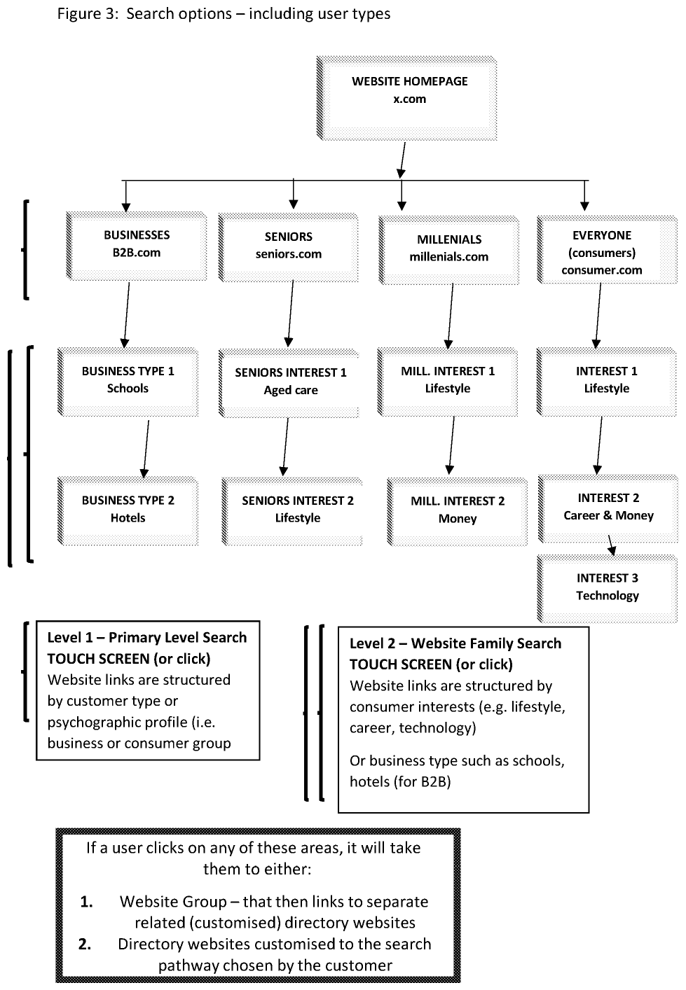

FIG. 3 presents in more detailed hierarchy tree structure of each button link on Levels 1 and 2—demonstrating how the search process is personalised. It also shows the touch screens and how they are aggregated by user type—that is, by psychographic or demographic profile (for consumer websites) and by business type (for B2B).

Note on some occasions—the psychography comes into effect at Level 3—Directory Website—via the search categories. An example is “Iwantthebestgifts.com.au”. While the user is selecting their interest (looking for a gift for someone)—the age, gender and interest of the giftee can be used in the keyword search to be of higher value to the user.

For example:
Primary Search Category—Female, Aged 50-60
Sub-category—Interest—Outdoors.

The Product & Service Framework (described in more detail) therefore needs to include demographic and interest categories for these directory websites.

FIG. 4 presents in tabular format for greater detail of how the user views and accesses the search information and process, for example, domain names of websites. Websites at all levels (1, 2 and 3) have their own domain name, and in this case, premium domain names already purchased that clearly define the purpose of the website, for example, SuppliersOnline.com.au (Level 2 Website Family—B2B example), HealthSuppliers.com.au (Level 2 Website Family—B2B example), FindWhatIWant.com.au (Level 2—Website Family—consumer example), SchoolSuppliers.com.au (Level 3 Directory Website—B2B example), FindWhatIWantcom.au (Level 2 Website Family—Consumer example), Iwantmyhousetolookgreat.com.au—Level 3 Directory Website—consumer example), FindSeniorsServices.com.au (Level 2 Website—consumer example). Independent websites with their own primary domain names generate a higher quality SEO result than one website with sub-domains or webpages.

At Level 3, the network of directory websites operates from third-party software. The benefit of this software is the provision of sophisticated search for customers—including predictive text keyword search in addition to Google Maps® capability so customers can easily source products and services provided to their market, in their location. That is, their current search requirement. For example, school users on the SchoolSuppliers.com.au website know that search results are matched to school requirements—that is qualified advertisers. Or advertisers that choose to offer products and services to the schools' market.

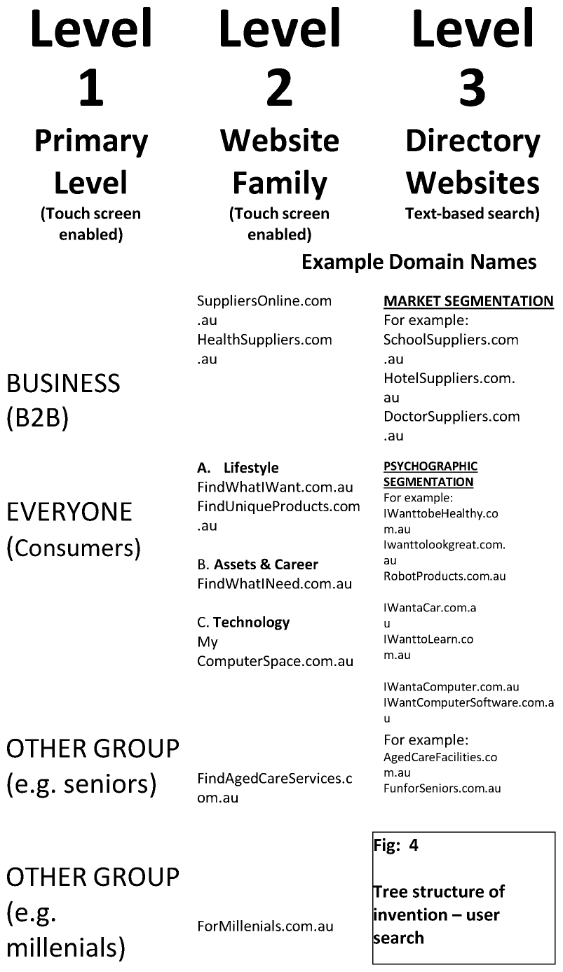

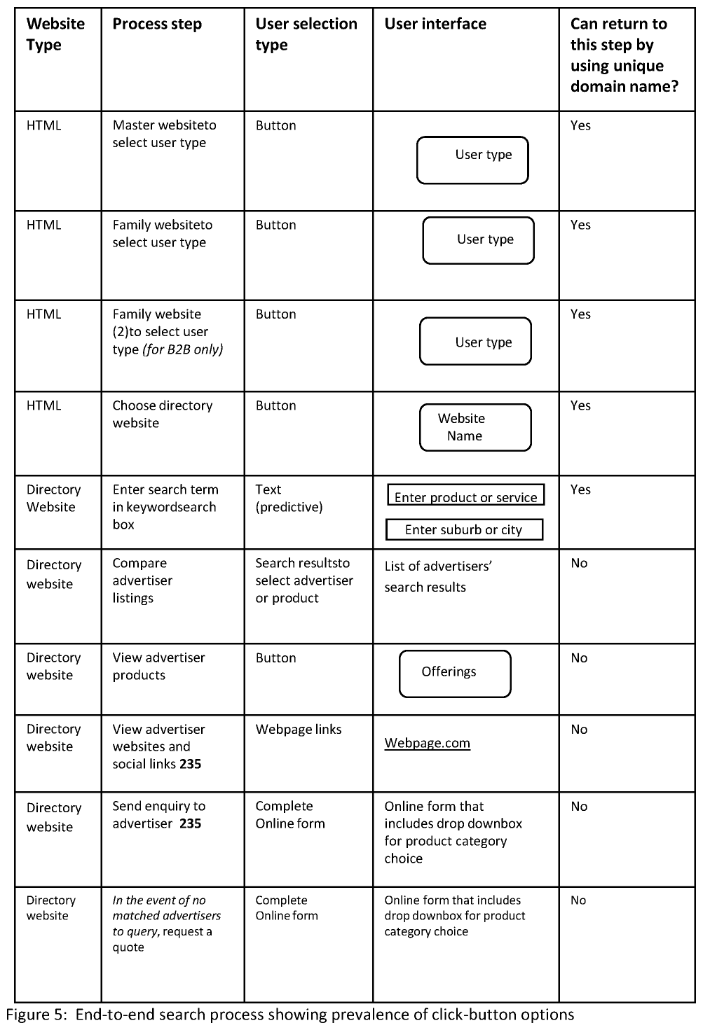

The end-to-end search process is streamlined to the extent that the user would perceive that all functionality is from one central platform. It is easy to use and quick to generate search results and identify qualified advertisers for their current search query. This is shown in FIG. 5 which displays the user interface choices at each step of the search process. Except for the keyword search at Level 3, all options for customers to design their search process or pathway are button options. This has significant advantages for business and consumers with touch pad digital devices, in addition to the disabled population.

As each step of the search pathway has its own domain name—as shown in FIG. 5—it is easy for a user to save time and skip steps 1 and 2 of their searches to find their desired directory website or website family for their next search. For example, a school employee can go straight to the SchoolSuppliers.com.au website to source suppliers for schools, and then use the Consumer pathway for a new search to find a new handbag for personal use.

If there are no search results to match the users' requirement—a message appears for the user to click a button to complete a “Request a Quote” form from the directory website—which is emailed directly to the platform owner. The platform owner can then use that information to attract new advertisers to the platform who provide products to that target market.

This approach of combining automatic “computer matching” with the human element helps to ensure that the growth of advertiser digital content on the search platform is directly aligned with customers' changing requirements.

As a result of this process, the search result generated for the user is:
Personalised to their user type and current search requirement:
   B2B example—lists suppliers that supply to schools, or schools are their preferred customer
   Consumer example—lists fashion items that are suitable for their age and gender (eg: Early 20s and female).
Comprehensive, comparable listings of each supplier to compare
Geography-based (ie: with Google Maps® capability).

Another feature of each directory website is the possibility for customers to be presented with “relevant recommendations I wouldn't have thought of myself” (McKinsey reference in prior art section). This is through a “Browse Categories” menu which shows links to all advertisers for all product and service categories relevant to that market. For example, there may be new software learning technologies for educational markets that are not yet known to most users.

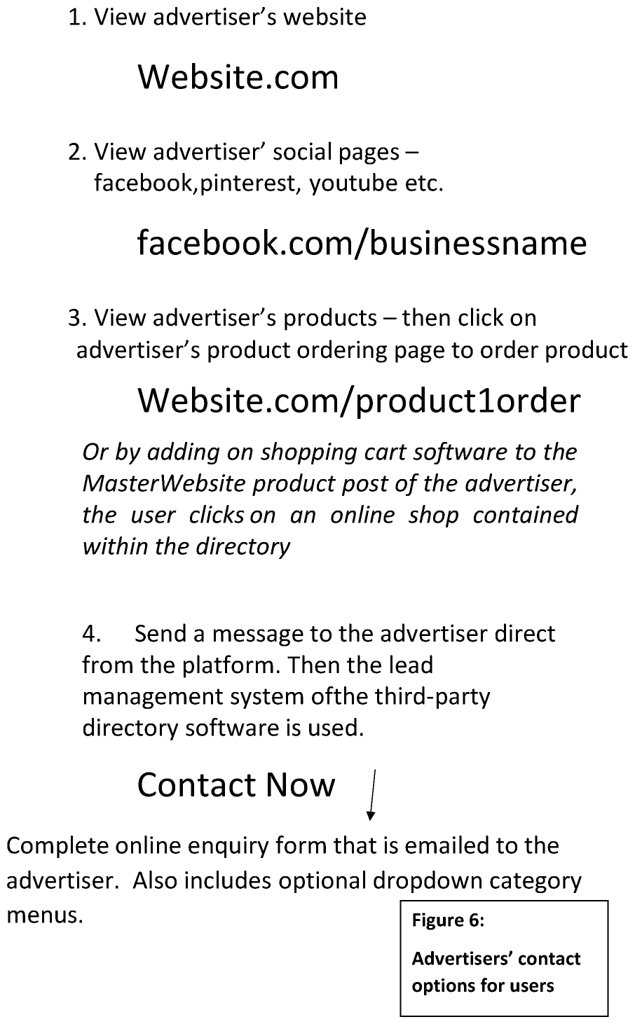

FIG. 6 displays the options for the user to contact advertisers of interest:
Click on the website link
Click on social pages link; or
Send an enquiry using a “Contact” button. The lead management system of the third-party directory software then comes into play so that enquiries are sent directly to advertisers to manage and respond.

The end-to-end search process has been designed for customers to have an easy, transparent and streamlined user experience—to find products personalised to their requirements—and their changing preferences.

The scope of search includes personalisation for both Business-to-Business (B2B) and consumer searches.

Advertiser Listing Process

To be of any value to the user, the quality of the results of the automated search process relies on advertisers to populate the directory websites with digital content (FIG. 1). This advertiser listing process has been designed to meet ease of use, appearance, precision and speed criteria—as they are not relying on a technology expert for their digital marketing strategy and need to upload content themselves to their desired markets.

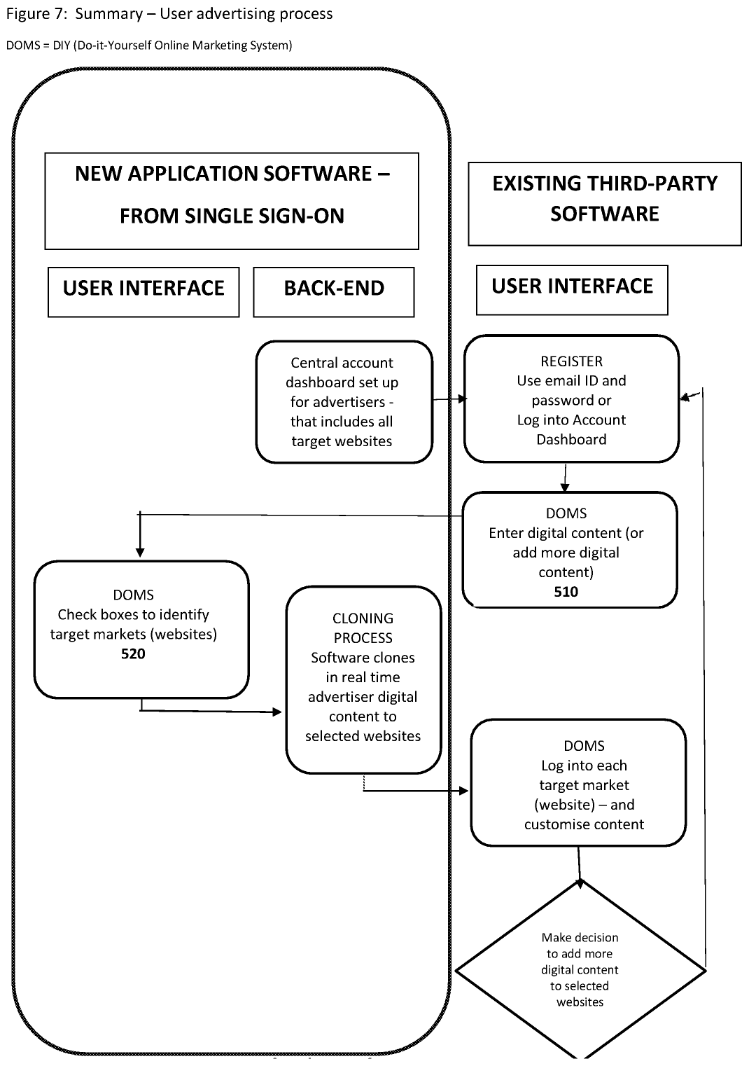

FIG. 7 provides an overview of the advertiser process to list products on the online platform. It shows how the components of both new application software and existing third-party software “work together” to provide an advertiser listing process to meet the forementioned criteria.

The single sign-on account dashboard from a master advertising website is developed via the new application software.

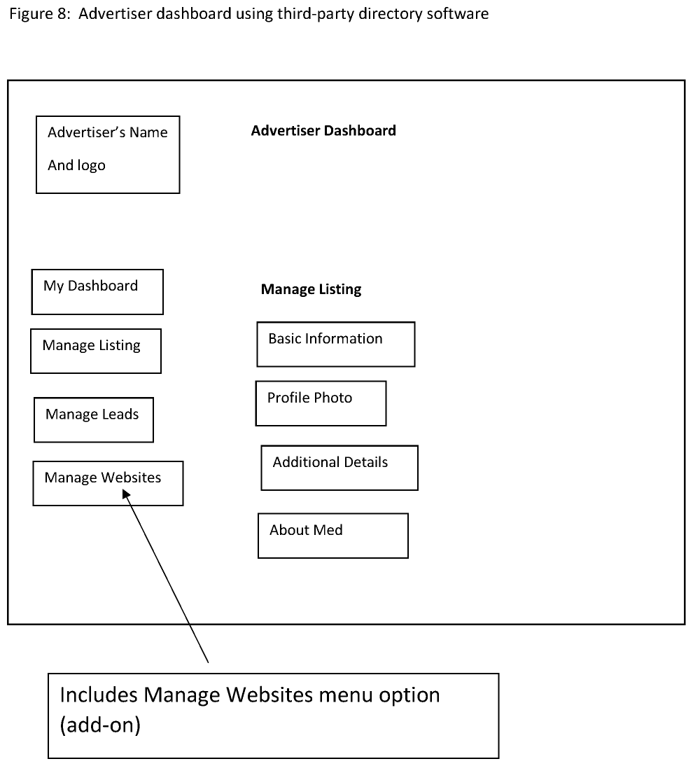

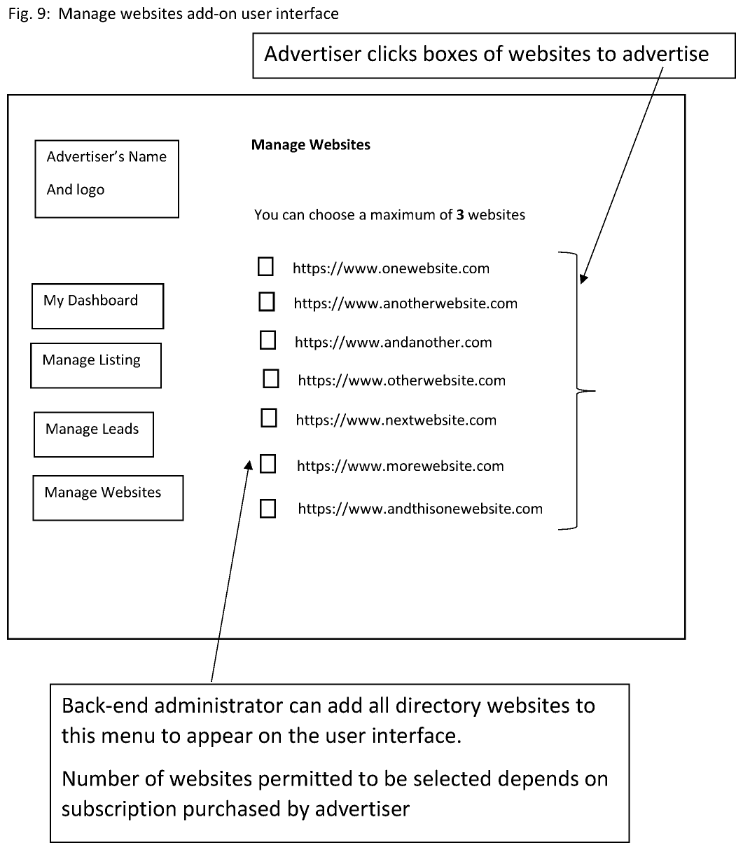

The user interface is from existing third party software—with an add-on to the software of a “Choose Websites” tab (FIG. 8 and FIG. 9).

This has been labelled for marketing reasons a DIY Online Marketing System (DOMS)—to demonstrate to advertisers that they can design their own online marketing strategy—rather than rely on costly technology experts to be found online and present a professional online profile.

The interface shows how quick and easy it is for advertisers to:
Upload their profile and contact information to the DOMS—to advertise instantly on multiple websites
Select which websites to list their products and services (that is, their preferred customers).

As shown in FIG. 7—software has been developed for the backend which clones the advertisers' digital content to their selected websites—in real time. In addition, sets up a new login account for that website with an identical username and password as the Master Advertising Website. This saves the advertiser significant time as they need not repeat the account setup and upload digital content to each website.

That is, by using the “integrated” DOMS, advertisers can display all their digital content on all websites of their choice quickly and easily.

After their profile information Is cloned to their choice of websites, advertisers can login to each of their selected websites and customise their digital content to that market, or of course add additional content.

This enables advertisers to fully customise their product and service offerings to their preferred customers on the online marketplace.

New Application Software

New application software has been developed, using Java, SQL and Python languages, to address the “missing link” with this search process that uses existing third-party directory software. That is, challenges presented for advertisers to list content across multiple directory websites. In most situations, advertisers will prefer to list in multiple websites on the platform—rather than just one. This widens the scope of their digital marketing strategy.

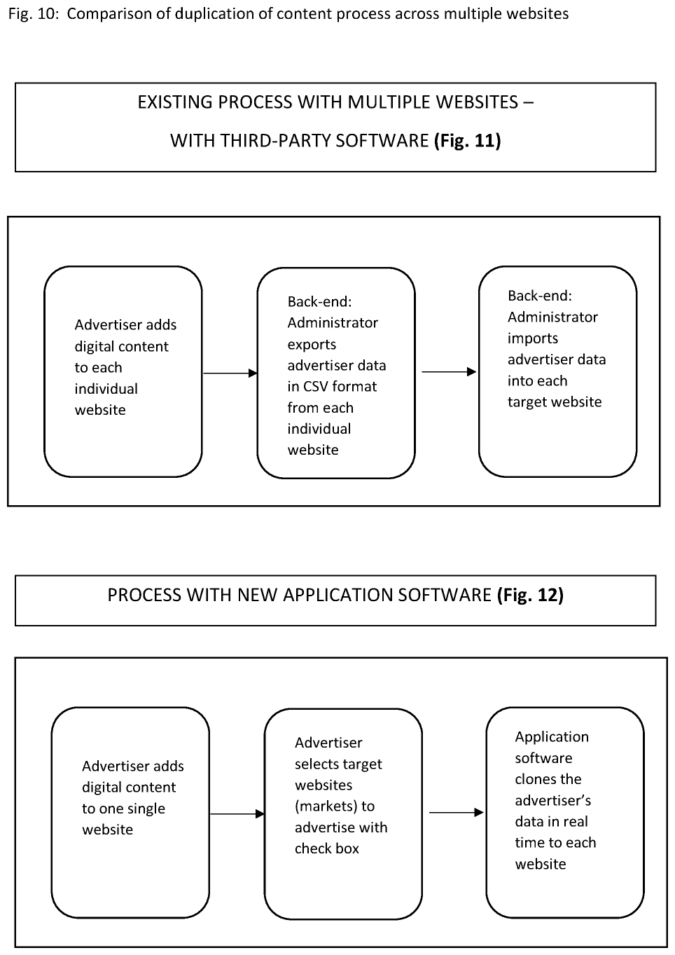

FIG. 10 compares the existing process of duplicating content across multiple websites (FIG. 11) to the more efficient process with the new software (FIG. 12). That is, summarising how the software saves the advertisers and platform administrators' time by duplicating advertisers' digital content, in real time, to their preferred markets (websites).

Advertisers have a single sign-on with the Member Dashboard which permits advertiser to login to a master website to add content—rather than do multiple logins to commence the listing process.

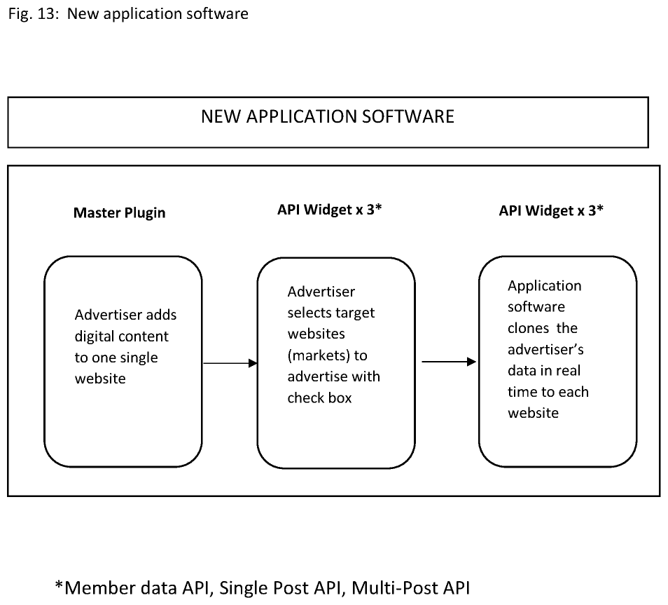

FIG. 13 shows the main components of the software—Master Plugin, API Widgets x 3 (for Master Website) and API Widgets x 3 (for “slave” websites).

The Master Website provides the single sign-on, the “slave” websites are the Level 3 directory websites (for example SchoolSuppliers.com.au).

The digital content is comprised of three types:
Member Posts—for example, contact information, service locations
Single Posts—upload a single image, for example, articles, blogs, events, jobs
Multi Posts—upload more than one image, for example, photo gallery, properties Each have different API widgets—Member Data API, Single Post API, Multi-Post API (FIG. 13).

The API widgets are designed to enable the advertiser to:
To allocate each post (for example blog)—to each target website
Log into any of the websites where they have an account—and customise that content to that market (website)—without those changes impacting the Master Plugin (that is—their generic content).

Product and Services Framework

The Product and Services Framework, underpinning the personalised search process, was developed by the inventor—a business psychologist. The product and service list meets these design requirements:
Easy to search and view for customers using third-party directory software
Enables search at a granular level by including a sub-category level
Looks user friendly and professional on home page of each website
Easy for advertisers to select their product offering.
Lists are customised for each customer market (or directory website).

The framework has been content validated and user tested with businesses and customers.

It contains:
Product and Service Main Categories (e.g., 62 in the Suppliers Online website family)
Sub-Categories (for example, 920 in the Suppliers Online website family)
Search keywords for each sub-category—adapted from common search words used on the internet.

Some of the categories and sub-categories are generic to many websites—others are market-specific (for example, Plant Stock (for Nursery Suppliers) and Alcohol Stock (for Bottle Shop Suppliers).

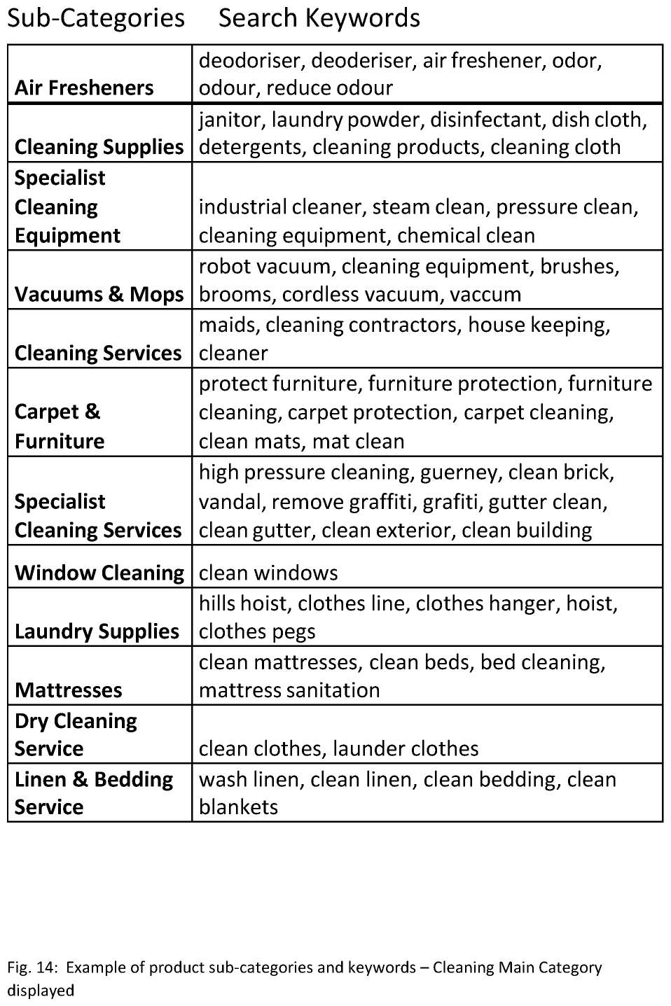

FIG. 14 shows an example of the Cleaning—Main Category—and associated Sub-Categories.

Domain Name Portfolio

The inventor has secured a domain name portfolio to support this process.

A domain name is allocated at all levels of the personalised search process, that is, Level 1: Master Websites, Level 2: Family Websites and Level 3: Directory Websites (FIG. 4).

The benefits of the domain name portfolio are:
The domain names are easy to remember and represent the purpose of each website—enabling easier selection decisions for both users and advertisers. Some have been selected based on common interests—for example, FindWhatIWant.com.au as a Website Family.
They enable the user to omit first parts of the search and skip to websites of choice to save time (once familiar with the search process)
Each directory website is stand-alone—better for SEO and asset value
Each website family represents a website portfolio that is stand-alone (for example, the Health Suppliers portfolio has 9 website directories)—better for SEO and asset value.
More effective SEO in general.

The portfolio covers “.com.au” domain names for an Australian market launch. In addition, equivalent “.com” domain names have been secured to launch a multi-national model.

Variations

Other variations this personalised search process include upgrading the DOMS software for advertisers to list banner ads (eg: Home page, Footer, Sidebar)—in each of the directory websites. The upgrade would include a change requirement—so that once an advertising position (that is, Banner position, website) was activated—that option could not be selected by another advertiser until that option is released. There also needs to be functionality for the advertiser to upload the banner image.

The domain name portfolio is not mandatory to the process—as various sub-domains or webpages could be developed at the Family Website and Directory Website levels (as is the case with Alibaba® and eBay®). However, this would take away many benefits such as less effective SEO and users unable to easily skip to any part of the search process to save time (for example, go straight to SchoolSuppliers.com.au)—once they are familiar with the search methodology.

The scope can be:
Local directory
National directory
Multi-national directory

### CONCLUSION

In conclusion, this process offers a different approach to personalised search for products and services online, than current approaches which primarily focus on ways to manage the exponential development of big data.

The end-to-end process is not impacted by any of the privacy invasion or lack of transparency and control issues of prior art as it is self-contained. In addition, it is used at the time the user is ready to research or make a purchase decision. It is also more likely that only qualified advertisers appear in a users' search results.

The embodiment of my search process for products and services online is a search pathway where users make decisions on their current search requirements and search process, thereby taking account of their dynamic preferences. The end-to-end search process is primarily “click-button” based set up as a tree structure, rather than text based—thereby being easy to use, particularly on mobile devices.

The process is assisted by a network of third-party directory websites, each with a unique domain name, that offers a search result at a granular level—in terms of both desired product and location availability.

The advertiser sign-up process is fully automated and is controlled via one centralised platform and an easy-to-use DIY Online Marketing System. Advertisers are incentivised to upload new digital content, via newly developed software that clones this content in real time to multiple websites—that is, their preferred markets—thereby saving them significant time. This process offers the advertiser a high degree of control and transparency of their digital marketing strategy and advertising spend.

The market scope is significant—being local, national or multi-nationally based. The target advertising market is any individual or business wanting to sell a product or service online. The target customer market is any business or consumer searching for a product or service online. The scope of product and services is any item that can be easily categorised for included markets.

The advertiser listing process can also be applied to website banner advertising.

The click-button based search process can be applied to improve user-friendliness with emerging future technologies, such as Virtual Reality (VR) and vertical transparent touch screens.

1.-21. (canceled)

22. A centralised, interactive user interface—from one master website—where users customise their own search for products and services—based on lifestyle choices—in the case of consumers; and based on business type—in the case of businesses; whereby the search results are presented via newly developed add-on linked software—where advertisers choose their preferred markets or customers; search results are therefore personalised as they match users' dynamic preferences with advertisers' choice of where and how to present their listings of said products and services; said listings include hyperlinks to advertisers' website, product purchase and social pages, plus lead management system for users to communicate directly with advertisers on same platform; thereby providing a streamlined search process for the customer; search results are also presented with granular detail via a structured network of third-party directory websites—with text-based, or menu drop-down, search functionality—to include location, product or service category; a newly developed Product and Service Framework—based on said product or service categories, and/or demographic/psychographic categories, underpins the final stage of the customers' search process.

23. Said user interface of claim 22 comprises a hierarchical tree structure of url links of website type groupings—for example, Master Website, then Primary Level, Website Family (family website) then connected to the network of said directory websites- to create a multiple website network that is customised to different said user choices of claim 22; said website type grouping and Directory websites are each represented as an independent website with a separate domain name that reflects the purpose of each step of the customers' search.

24. Said user interface of claim 22 is a self-contained platform that can be applied at any geographic level—including city, country, multi-national—and can be applied to business-to-business and consumer searches; it can include searches for any item that can be categorised under a product or service categorisation system.

25. A centralised user interface on one master website where advertisers of products and services design their own marketing strategy—based on said newly developed add-on linked software of claim 22—with a “Choose Websites” tab—also linked to said third party directory websites of claim 22; in said user interface, advertisers choose which websites, listed as a multiple directory website network in the form of tick boxes, to clone their account information and digital content in real time from their master website to slave websites—to target their preferred customers.

26. Said user interface of claim 25 includes newly developed central account dashboard to help advertisers to customise said digital content in each slave website of claim 25.

27. Back-end administration panel of centralised user interface of claim 25 has add-on software widgets for each directory website in the network.

28. Said software widgets of claim 27 have multiple APIs to enable advertisers to choose which digital content to display in each said chosen slave website.

29. Said software widgets of claim 28 include setting up member access to each selected slave website using same email address and password login details.

30. Said digital content of claim 25 can include business profile information, product categories and sub-categories, website and social page links, in addition to posts with single images—for example, articles, blogs, events, plus posts with multiple images such as product posts and photo galleries.

31. Advertisers can respond directly to enquiry messages from customers with a lead management system—using said member logins of claim 29 of each Directory website—that are customised to the customer user type.

32. Said centralised user interface of claim 25 demonstrate a fast, streamlined and granular end-to-end online advertising process so that advertisers can customise their product and service offerings online to their preferred target markets or customers.

33. Said centralised user interface for advertisers of claim 25 is a self-contained platform that can be managed by the same entity.

34. Said centralised user interface for advertisers of claim 25 can be applied at any geographic level—including city, country, multi-national—and can be applied to business-to-business and consumer searches; it can include any item that can be categorised under a product or service categorisation system.
